(19) United States
(12) Patent Application Publication
(10) Pub. No.: US 2020/0294211 A1
(43) Pub. Date: Sep. 17, 2020

(54) IMAGE DISPLAY APPARATUS, IMAGE SUPPLY APPARATUS, AND CONTROL METHOD THEREOF

(71) Applicant: CANON KABUSHIKI KAISHA, Tokyo (JP)

(72) Inventors: Shuhei Iino, Kawasaki-shi (JP); Tatsuya Nishiguchi, Kawasaki-shi (JP)

(21) Appl. No.: 16/776,745

(22) Filed: Jan. 30, 2020

(30) Foreign Application Priority Data
Mar. 13, 2019 (JP) 2019-046382

(51) Int. Cl. G06T 5/00; H04N 5/235; G06T 5/20

(52) U.S. Cl. CPC G06T 5/008; G06T 5/20; H04N 5/2355

(57) ABSTRACT

An image display apparatus determines, based on information obtained from an image supply apparatus via a communication interface, whether or not the image display apparatus has a capability of displaying an image of a first dynamic range that is generated in the image supply apparatus, and if the image display apparatus has a capability of displaying an image of the first dynamic range, requests the image supply apparatus for an image of the first dynamic range, and if the image display apparatus does not have a capability of displaying an image of the first dynamic range, requests the image supply apparatus for an image of a second dynamic range that can be displayed on the image display apparatus.

### BACKGROUND OF THE INVENTION

### Field of the Invention

The present invention relates to a system in which an image supply apparatus and an image display apparatus are connected.

### Description of the Related Art

Display apparatuses that can display images in a dynamic range wider than a conventional dynamic range have emerged. A dynamic range that can be expressed by a conventional display apparatus is called an SDR (Standard Dynamic Range), and a dynamic range wider than a dynamic range that can be expressed by a conventional display apparatus is called an HDR (High Dynamic Range).

When an HDR image is displayed on an SDR-compliant (non-HDR-compliant) display apparatus, “blocked up shadows” and “blown-out highlights” occur in high-contrast portions, and an appropriate HDR image cannot be displayed. Therefore, in Japanese Patent Laid-Open No. 2017-220690, in a system in which a reproduction apparatus and a display apparatus are connected using HDMI®, the reproduction apparatus obtains the dynamic range of an image that can be displayed by the display apparatus (display capability), and changes the dynamic range of a video image that is to be output, in accordance with the display capability of the display apparatus.

However, in Japanese Patent Laid-Open No. 2017-220690, the display capability of the display apparatus is taken into consideration, but, if the reproduction apparatus can generate images of different dynamic ranges, the dynamic range of an image that the reproduction apparatus generates in the current setting or state, and the like are not taken into consideration.

### SUMMARY OF THE INVENTION

The present invention has been made in consideration of the aforementioned problems, and realizes techniques that can request and display an appropriate image in consideration of not only the display capability of an image display apparatus but also a setting of an image that is generated by an image supply apparatus.

In order to solve the aforementioned problems, the present invention provides an image display apparatus comprising: a memory and at least one processor and/or at least one circuit; a communication interface configured to communicate with an image supply apparatus; and a display unit configured to display an image obtained from the image supply apparatus, wherein the processor and/or the circuit function as a determination unit and a control unit, wherein the determination unit is configured to determine, based on information obtained from the image supply apparatus via the communication interface, whether or not the image display apparatus has a capability of displaying an image of a first dynamic range that is generated in the image supply apparatus, and the control unit is configured to, if the image display apparatus has a capability of displaying an image of the first dynamic range, request the image supply apparatus for an image of the first dynamic range, and if the image display apparatus does not have a capability of displaying an image of the first dynamic range, request the image supply apparatus for an image of a second dynamic range that can be displayed on the image display apparatus.

In order to solve the aforementioned problems, the present invention provides an image supply apparatus comprising: a memory and at least one processor and/or at least one circuit; and a communication interface configured to communicate with an image display apparatus; wherein the processor and/or the circuit function as a generation unit, a switching unit and a control unit, wherein the generation unit is configured to generate images of different dynamic ranges, the switching unit is configured to switch to a first mode for generating an image of a first dynamic range or a second mode for generating an image of a second dynamic range, and the control unit is configured to, when an image of the first dynamic range is requested from the image display apparatus in a state where the first mode is set by the switching unit, supply an image of the first dynamic range generated by the generation unit to the image display apparatus, and, when an image of the second dynamic range is requested from the image display apparatus, cause the generation unit to generate an image of the second dynamic range, and supply the generated image to the image display apparatus.

In order to solve the aforementioned problems, the present invention provides a method of controlling an image display apparatus having a communication interface configured to communicate with an image supply apparatus, the method comprising: determining, based on information obtained from the image supply apparatus via the communication interface, whether or not the image display apparatus has a capability of displaying an image of a first dynamic range that is generated in the image supply apparatus; if the image display apparatus has a capability of displaying an image of the first dynamic range, requesting the image supply apparatus for an image of the first dynamic range, and if the image display apparatus does not have a capability of displaying an image of the first dynamic range, requesting the image supply apparatus for an image of a second dynamic range that can be displayed on the image display apparatus; and displaying an image obtained from the image supply apparatus.

In order to solve the aforementioned problems, the present invention provides a method of controlling an image supply apparatus that includes a communication interface configured to communicate with an image supply apparatus and a generation unit configured to generate images of different dynamic ranges, and can be switched to a first mode for generating an image of a first dynamic range or a second mode for generating an image of a second dynamic range, the method comprising: when an image of the first dynamic range is requested from the image display apparatus in a state where the first mode is set, supplying an image of the first dynamic range generated by the generation unit to the image display apparatus, and, when an image of the second dynamic range is requested from the image display apparatus, causing the generation unit to generate an image of the second dynamic range, and supplying the generated image to the image display apparatus.

In order to solve the aforementioned problems, the present invention provides a non-transitory computer-readable storage medium storing a program that causes a computer to execute a method of controlling an image display apparatus having a communication interface configured to communicate with an image supply apparatus, the method comprising: determining, based on information obtained from the image supply apparatus via the communication interface, whether or not the image display apparatus has a capability of displaying an image of a first dynamic range that is generated in the image supply apparatus; if the image display apparatus has a capability of displaying an image of the first dynamic range, requesting the image supply apparatus for an image of the first dynamic range, and if the image display apparatus does not have a capability of displaying an image of the first dynamic range, requesting the image supply apparatus for an image of a second dynamic range that can be displayed on the image display apparatus; and displaying an image obtained from the image supply apparatus.

In order to solve the aforementioned problems, the present invention provides a non-transitory computer-readable storage medium storing a program that causes a computer to execute a method of controlling an image supply apparatus that includes a communication interface configured to communicate with an image supply apparatus and a generation unit configured to generate images of different dynamic ranges, and can be switched to a first mode for generating an image of a first dynamic range or a second mode for generating an image of a second dynamic range, the method comprising: when an image of the first dynamic range is requested from the image display apparatus in a state where the first mode is set, supplying an image of the first dynamic range generated by the generation unit to the image display apparatus, and, when an image of the second dynamic range is requested from the image display apparatus, causing the generation unit to generate an image of the second dynamic range, and supplying the generated image to the image display apparatus.

According to the present invention, it is possible to request and display an appropriate image in consideration of not only the display capability of an image display apparatus but also a setting of an image that is generated by an image supply apparatus.

Further features of the present invention will become apparent from the following description of exemplary embodiments (with reference to the attached drawings).

### BRIEF DESCRIPTION OF THE DRAWINGS

FIG. 1 is a diagram showing a system configuration of an embodiment of the present invention.

FIG. 2A is a block diagram showing the configuration of an image supply apparatus of an embodiment of the present invention.

FIGS. 2B and 2C are a front view and a rear view of the image supply apparatus of an embodiment of the present invention.

FIG. 3 is a block diagram showing the configuration of an image display apparatus of an embodiment of the present invention.

FIG. 4 is a flowchart showing processing of the image supply apparatus of an embodiment of the present invention.

FIG. 5 is a flowchart showing processing of the image display apparatus of an embodiment of the present invention.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

System Configuration

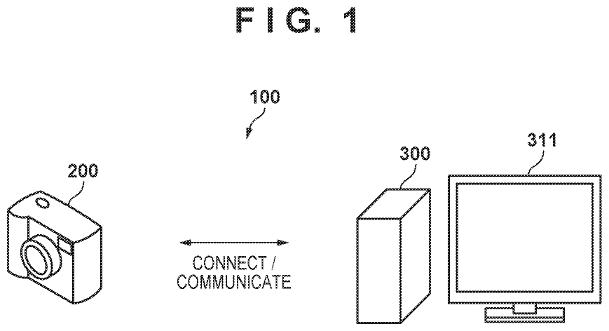

First, a system configuration of this embodiment will be described with reference to FIG. 1.

In a system 100 of this embodiment, an image supply apparatus 200 that shoots an image and supplies the image to an image display apparatus 300 and the image display apparatus 300 that receives an image from the image supply apparatus 200 and displays the image are communicably connected. The image display apparatus 300 remotely controls the image supply apparatus 200, receives an image shot by the image supply apparatus 200 via wired communication unit or wireless communication unit, and displays the image on a display unit. Note that the image supply apparatus 200 of this embodiment is an image capture apparatus such as a digital camera, network camera, surveillance cameras, medical camera, or on-vehicle camera that has a communication function, or a communication apparatus such as a smart phone or a tablet PC that has a camera function. Also, the image display apparatus 300 of this embodiment is a communication apparatus such as a mobile phone or a smart phone that is a type of mobile phone, a wearable computer such as a wristwatch-type smart watch or eyewear-type smart glasses, or an information processing apparatus such as a desktop PC or a tablet PC.

The image supply apparatus 200 transmits/receives various types of data to/from the image display apparatus 300 connected thereto via a wired or wireless network. The image supply apparatus 200 transmits a live-view image to the image display apparatus 300 via the network, and the image display apparatus 300 displays the live-view image received from the image supply apparatus 200.

The image supply apparatus 200 can generate an HDR image (including a live-view image) by developing a shot image (raw image) in an HDR (High Dynamic Range) mode. Also, the image supply apparatus 200 can generate an SDR image (including a live-view image) by developing a raw image in an SDR (Standard Dynamic Range) mode. Furthermore, the image supply apparatus 200 can perform dynamic range conversion processing for converting an HDR image into an SDR image. An SDR is a gradation characteristic corresponding to a dynamic range that a conventional display apparatus can display, and is stipulated in a standard called ITU-R BT.709, for example. In contrast, an HDR that is wider than a dynamic range that a conventional display apparatus can display is stipulated in a standard called Rec.ITU-R BT.2100.

In addition, the image supply apparatus 200 can be set to either an HDR shooting mode for outputting an HDR image to the image display apparatus 300, which is an output destination of image data, or a non-HDR shooting mode (SDR shooting mode) for outputting an SDR image. In the HDR shooting mode, the image supply apparatus 200 can output an HDR image to the output destination, and, in the non-HDR mode, can output an SDR image to the output destination.

Upon receiving a live view start request from the image display apparatus 300, the image supply apparatus 200 generates, in the HDR or SDR mode, a live-view image obtained by developing a shot raw image, and transmits the live-view image to the image display apparatus 300. In addition, in the HDR shooting mode, the image supply apparatus 200 can set the dynamic range of a live-view image to HDR or SDR in accordance with a request from the image display apparatus 300. When an SDR live-view image is requested from the image display apparatus 300, the image supply apparatus 200 generates an SDR live-view image through dynamic range conversion processing that is based on the setting of a dynamic range conversion function.

If the dynamic range of a live-view image that is generated by the image supply apparatus 200 can be switched, the image display apparatus 300 can specify a dynamic range of a live-view image that is desired to be received from the image supply apparatus 200 before live view is started. When the image supply apparatus 200 is set to the HDR shooting mode, if the image display apparatus 300 itself can handle display of an HDR image, the image display apparatus 300 requests the image supply apparatus 200 for an HDR live-view image. Also, when the image supply apparatus 200 is set to the HDR shooting mode, but the image display apparatus 300 itself cannot handle display of an HDR image, the image display apparatus 300 requests the image supply apparatus 200 for an SDR live-view image. Furthermore, when the image supply apparatus 200 is set to the non-HDR shooting mode (SDR shooting mode), the image display apparatus 300 requests the image supply apparatus 200 for an SDR live-view image.

Configuration of Image Supply Apparatus 200

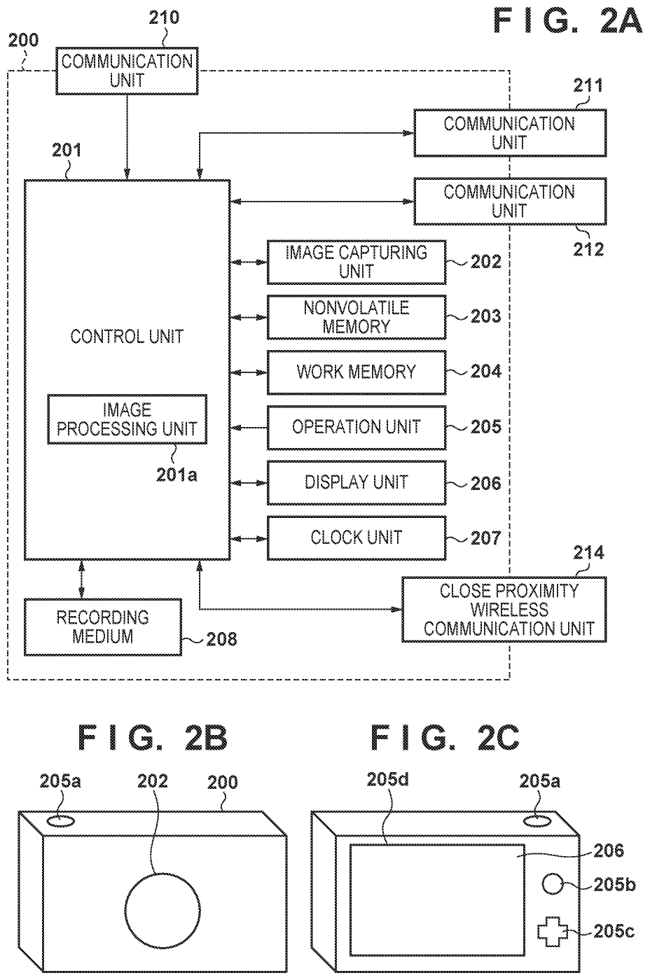

Next, the configuration and functions of the image supply apparatus 200 of the present embodiment will be described with reference to FIG. 2A.

A control unit 201 is an arithmetic processing unit (CPU), which comprehensively controls an entirety of the image supply apparatus 200, and implements processing during a remote shooting (to be described later) by executing programs stored in a nonvolatile memory 203 (to be described later). Note that a plurality of pieces of hardware may control the entirety of the apparatus by sharing processes instead of the control unit 201 controlling the entirety of the apparatus.

An image capturing unit 202 includes a lens group including a zoom lens and a focus lens and a shutter having a stop function. The image capturing unit 202 also includes an image sensor formed from a CCD, CMOS element, or the like which converts an object image into electrical signal, and an A/D converter which converts the analog image signal output from the image sensor into digital signal. Under the control of the control unit 201, the image capturing unit 202 converts optical image of an object formed by the lens included in the image capturing unit 202 into electric signal by the image sensor, performs noise reduction processing or the like on the converted signal, and outputs image data composed of digital signal.

The control unit 201 includes an image processing unit 201a. The image processing unit 201a performs resizing processing, such as pixel interpolation and reduction, and color conversion processing on image data captured by the image capturing unit 202. The image processing unit 201a also performs compression encoding complying with JPEG or the like, on still image data that has undergone the above-described processing, or performs encoding complying with a moving image compression method such as MPEG2 or H.264, on moving image data, to generate an image file, and records the image file on a recording medium 208. The image supply apparatus 200 according to the present embodiment records image data on the recording medium 208 according to the DCF (Design rule for Camera File system) standards. The image processing unit 201a also performs predetermined arithmetic processing using captured image data, and the control unit 201 performs AF (Auto Focus) processing, AE (Auto Exposure) processing, and so on by controlling the focus lens, the stop, and the shutter of the image capturing unit 202 based on the results of arithmetic processing.

In addition, the image processing unit 201a can generate an HDR live-view image by developing, in the HDR mode, a raw image data output from the image capturing unit 202. The image processing unit 201a can also generate an SDR live-view image by developing, in the SDR mode, a raw image output from the image capturing unit 202.

In addition, the control unit 201 can switch the dynamic range of image data to be output to the image display apparatus 300, between HDR and SDR in accordance with a dynamic range of an image requested from the image display apparatus 300 that is an external apparatus. If an SDR image is requested from the image display apparatus 300, the image processing unit 201a performs dynamic range conversion processing for converting the dynamic range of image data that is to be output, from HDR into SDR. The image processing unit 201a generates an SDR image by performing dynamic range conversion processing according to the setting of the dynamic range conversion function.

In the dynamic range conversion function, when converting an HDR image into an SDR image, the conversion is performed with priority given to a specific range of the HDR image, and characteristic information in the HDR image can be reflected on an SDR image. The setting of the dynamic range conversion function can be made in the image supply apparatus 200 by the user. Assume that, in the image supply apparatus 200, “SDR conversion processing 1” and “SDR conversion processing 2” can be executed as the dynamic range conversion function. For example, the SDR conversion processing 1 is SDR conversion processing that can express higher gradation than predetermined luminance by assigning gradation on the high-luminance side of the HDR image. The SDR conversion processing 2 is SDR conversion processing that can express gradation lower than the predetermined luminance by assigning gradation on the low-luminance side of the HDR image.

The nonvolatile memory 203 is an electrically erasable/recordable memory, and, for example, an EEPROM is used. Constants, programs, and the like for the operation of the control unit 201 are recorded in the nonvolatile memory 203. Here, the programs are those for executing processing during the remote shooting which will be described later in the present embodiment.

A work memory 204 is used as a work area where constants and variables for the operation of the control unit 201, programs read out from the nonvolatile memory 203, and the like are to be loaded. The work memory 204 is also used as a buffer memory for temporarily storing the image data captured by the image capturing unit 202 or an image display memory for a display unit 206.

An operation unit 205 is constituted by operation members such as various types of switches and buttons, and a touch panel, which accept various types of operations from the user. The operation unit 205 includes, for example, a shutter button 205a for performing image shooting, a reproduction button 205b for performing a reproduction of shot images, and four-directional keys 205c constituted by up, down, left and right buttons for various settings of the camera, as shown in FIGS. 2B and 2C. In addition, the operation unit 205 also includes mode switch buttons for changing the operation mode of the image supply apparatus 200 to a still image shooting mode, a moving image recording mode (for remote shooting as well), or a play mode. The operation unit 205 also includes a touch panel 205d that is formed integrally with the display unit 206. The operation unit 205 also includes an operation member such as a dedicated connection button for starting a communication with an image display apparatus 300 as an external apparatus.

The shutter button 205a is turned on to generate a first shutter switch signal SW1 when the shutter button 205a is operated halfway, that is, half-pressed (a shooting preparation instruction). Upon receiving the first shutter switch signal SW1, the control unit 201 controls the image capturing unit 202 to start an operation such as AF (Auto Focus) processing, AE (Auto Exposure) processing, AWB (Auto White Balance) processing, or EF (Electronic Flash) processing. Also, the shutter button 205a is turned on to generate a second shutter switch signal SW2 when the shutter button 205a is operated completely, that is, full-pressed (a shooting instruction). Upon receiving the second shutter switch signal SW2, the control unit 201 starts a series of shooting operations from reading out a signal from the image capturing unit 202 to writing image data in the recording medium 208.

The display unit 206 displays, for example, a viewfinder image at the time of shooting, a captured image, and characters for a dialogical operation. The display unit 206 is, for example, a display device such as a liquid crystal display or an organic EL display. The display unit 206 may be formed integrally with the image supply apparatus 200, or an external apparatus connected to the image supply apparatus 200. The image supply apparatus 200 needs only be connectable to the display unit 206 and have the function of controlling display performed by the display unit 206.

A clock unit 207 counts a time based on time information set by the user, time information obtained via the communication units 210, 211, 212, and time information captured by a radio clock. A configuration may also be adopted in which the clock unit 207 can obtain time information from a mechanism such as an analog clock using a detection mechanism (in this case, the clock unit 207 includes the detection mechanism for obtaining time information from the analog clock).

Image data output from the image capturing unit 202 is recorded on the recording medium 208, and an image file that has been recorded thereon by the control unit 201 is read out from the recording medium 208. The recording medium 208 may be a memory card or a hard disk drive that is externally attached to the image supply apparatus 200, or a flash memory or a hard disk drive that is built into the image supply apparatus 200. The image supply apparatus 200 may have at least a function for accessing the recording medium 208.

Communication units 210, 211, 212 are interfaces for communicably connecting to an external apparatus such as the image display apparatus 300. The supply apparatus 200 according to the present embodiment can exchange data with an external apparatus via the communication units 210, 211, 212. For example, image data generated in the image processing unit 201a can be transmitted to an external apparatus via the communication units 210, 211, 212. Note that, in the present embodiment, the communication units 210, 211, 212 include a wired connection interface such as a USB cable, HDM® or IEEE1394, or a wireless connection interface for communication with an external apparatus via a wireless LAN (Local Area Network) complying with the IEEE 802.11 standards, Bluetooth complying with the IEEE 802.15 standards, an infrared communication interface and a wireless USB. The control unit 201 implements wireless communication with an external apparatus by controlling the communication units 210, 211, 212.

Note that, for example, if the communication unit 210 is a wired connection interface, and the communication units 211, 212 are wireless communication interfaces, the control unit 201 performs control so as to prevent the communication units 211, 212 from performing simultaneous communication in order to prevent intervention of communication of the communication units 211, 212.

In addition, the control unit 201 receives a live view start request and a request to transmit a live-view image whose dynamic range is specified, from the image display apparatus 300 connected thereto via the communication units 210, 211, 212, and can compress a live-view image to the specified dynamic range, and transmit the compressed live-view image to the image display apparatus 300. Regarding image data, for example, an HDR live-view image is generated by compressing a 10-bit YUV422 data to H.265 (ISO/IEC 23008-2 HEVC), and an SDR live-view image is generated by compressing a 10-bit YUV422 data to JPEG. The compression method is not limited thereto.

A close proximity wireless communication unit 214 includes, for example, an antenna for wireless communication, a modulation/demodulation circuit for processing wireless signal, and a communication controller. The close proximity wireless communication unit 214 outputs modulated wireless signal from the antenna and demodulates the wireless signal received by the antenna, whereby non-contact near field communication complying with the ISO/IEC18092 standard (so-called NFC: Near Field Communication) is implemented. The close proximity wireless communication unit 214 of the present embodiment is arranged on the side portion of the image supply apparatus 200.

Configuration of Image Display Apparatus 300

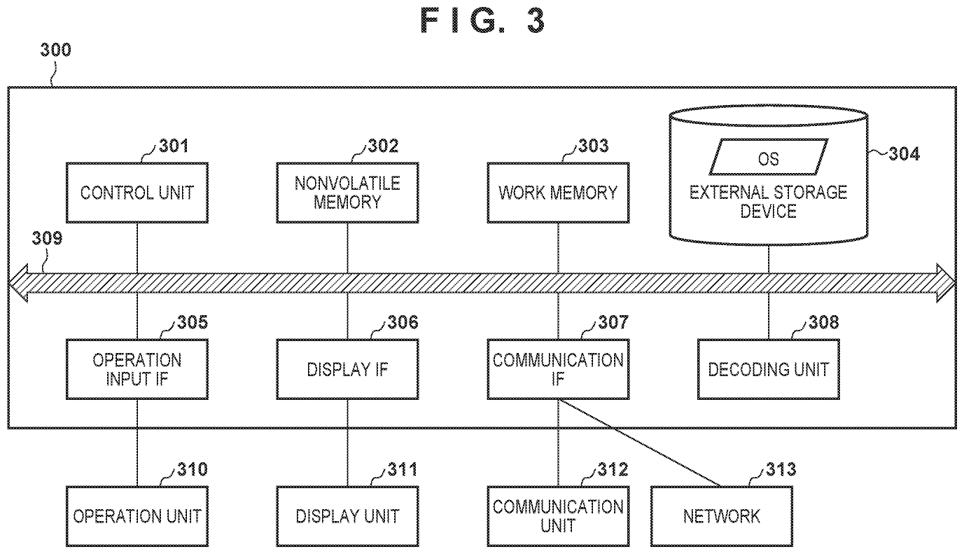

Next, the configuration and functions of the image display apparatus 300 of the present embodiment will be described with reference to FIG. 3.

A control unit 301 is a CPU (Central Processing Unit) that controls an entirety of the image display apparatus 300. A nonvolatile memory 302 is a ROM (Read Only Memory) that stores various types of control programs executed by the CPU of the control unit 301, and parameters. A work memory 303 is a RAM (Random Access Memory) that temporarily stores programs and data that are necessary for various types of processing executed by the CPU of the control unit 301. Note that a plurality of pieces of hardware may control the entirety of the apparatus by sharing processes instead of the control unit 301 controlling the entirety of the apparatus.

An external storage device 304 includes, for example, a hard disk or a memory card built in the image display apparatus 300, or a hard disk, a memory card, a USB flash memory, a DVD, or a Blu-ray disc that can be loaded into and removed from the image display apparatus 300. The external storage device 304 sores an OS (operating system) that is the basic software and executed by the control unit 301 and an application that implements a practical function by working in cooperation with the OS. Processing of the image display apparatus 300 during the remote shooting of the present embodiment are implemented by reading software provided by the application. It is assumed that the application includes software for utilizing the basic functions of the OS that is installed on the image display apparatus 300. Alternatively, the OS installed on the image display apparatus 300 may include software for implementing processing according to the present embodiment. The application of the present embodiment is assumed to be an application for remotely controlling the image supply apparatus 200. In the present embodiment, processing of the image display apparatus 300 is implemented by the control unit 301 executing the OS or the application and controlling each unit. However, the present embodiment is not limited to this, and the application may be supplied from an external apparatus connected to the network 313 via the communication IF 307.

An operation input IF 305 is an interface that accepts user operations via an operation unit 310. The operation unit 310 is an input device, such as a pointing device, a keyboard, and a touchscreen for inputting data. A display IF 306 is an interface that displays, on a display unit 311, data held in the image display apparatus 300 and data supplied from an external apparatus.

The display unit 311 is, for example, a display device such as a liquid crystal display or an organic EL display. The display unit 311 may be formed integrally with the image display apparatus 300, or an external apparatus connected to the image display apparatus 300. The image display apparatus 300 needs only be connectable to the display unit 311 and have the function of controlling display performed by the display unit 311.

A communication IF 307 is an interface that connects to an external apparatus such as the image supply apparatus 200 and a network 313 such as the Internet, via a communication unit 312. The communication unit 312 is an interface that connects to the communication units 210, 211, 212 of the image supply apparatus 200 as an external apparatus and inputs image data or the like from the image supply apparatus 200.

A decoding unit 308 decodes HDR image data and/or SDR image data in a compressed format received from the image supply apparatus 200. The decoding processing is performed in accordance with the compression methods of HDR image data and SDR image data. For example, if image data is compressed to H.265 (ISO/IEC 23008-2 HEVC), the image data is converted into YCbCr (YUV422) data, and is then converted into 10-bit bitmap data. Also, if image data is compressed to the JPEG format, the image data is converted into 8-bit bitmap data. Note that conversion may also be performed into data in a YUV format other than YCbCr (YUV422) data, or may also be performed into bitmap data having the number of bits larger than 10 bits.

The above-described components 301 to 308 are communicably connected by a system bus 309.

Processing of Image Supply Apparatus 200

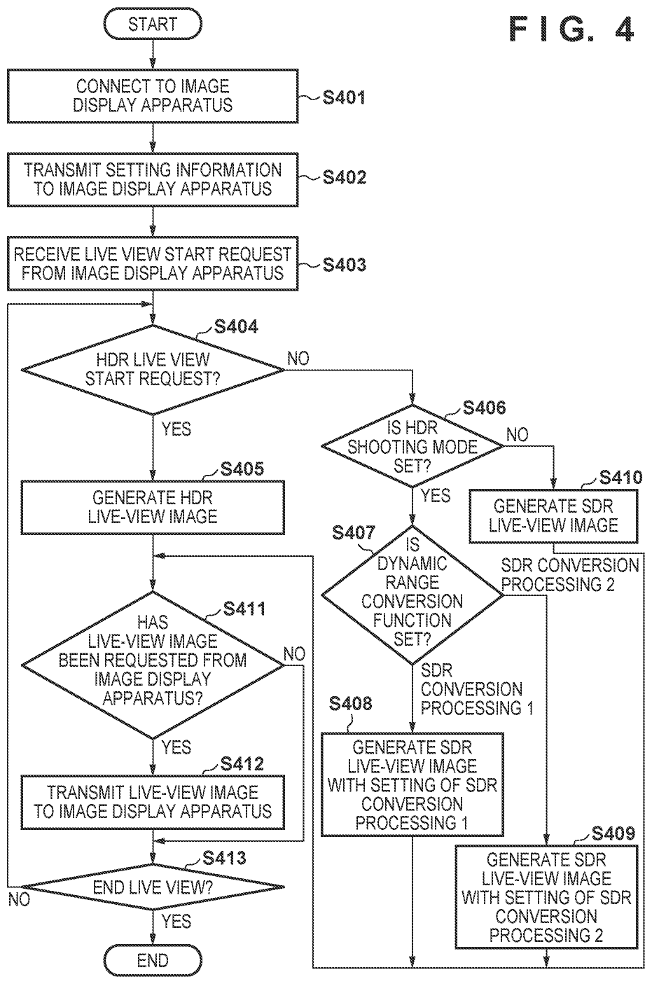

Next, processing of the image supply apparatus 200 during remote shooting according to this embodiment will be described with reference to FIG. 4.

Note that the processing in FIG. 4 is realized by the control unit 201 of the image supply apparatus 200 deploying a program stored in the nonvolatile memory 203 to the work memory 204 and executing the program. In addition, assume that, in FIG. 4, an application of remote shooting has been started in the image supply apparatus 200.

In step S401, the control unit 201 is communicably connected to the communication unit 312 of the image display apparatus 300 via at least one of the communication units 210, 211, 212.

In step S402, the control unit 201 transmits setting information of the image supply apparatus 200 to the image display apparatus 300. The setting information of the image supply apparatus 200 includes at least information regarding the HDR shooting mode of the image supply apparatus 200. Hereinafter, if the setting information of the image supply apparatus 200 is changed during processing, the setting information is transmitted from the image supply apparatus 200 to the image display apparatus 300 every time a change is made.

In step S403, the control unit 201 receives a live view start request from the image display apparatus 300.

In step S404, the control unit 201 determines whether or not the live view start request received in step S403 is an HDR live view start request. If it is determined that the live view start request is an HDR live view start request, the control unit 201 advances the procedure to step S405, and if it is determined that the live view start request is an SDR live view start request, advances the procedure to step S406.

In step S405, the control unit 201 causes the image processing unit 201a to generate an HDR live-view image.

In step S406, the control unit 201 determines whether or not the HDR shooting mode is set. If it is determined that the HDR shooting mode is set, the control unit 201 advances the procedure to step S407, and, if it is determined that the HDR shooting mode is not set, advances the procedure to step S410.

In step S407, the control unit 201 makes a determination on the setting of the dynamic range conversion function of the image supply apparatus 200. If it is determined that the setting of the dynamic range conversion function of the image supply apparatus 200 is the SDR conversion processing 1, the control unit 201 advances the procedure to step S408, and if it is determined that the setting of the dynamic range conversion function of the image supply apparatus 200 is the SDR conversion processing 2, advances the procedure to step S409.

In step S408, the control unit 201 performs dynamic range conversion processing from HDR into SDR in accordance with the setting of the dynamic range conversion function defined in the image processing unit 201a as the SDR conversion processing 1, and generates an SDR live-view image.

In step S409, the control unit 201 performs dynamic range conversion processing from HDR into SDR in accordance with the setting of the dynamic range conversion function defined in the image processing unit 201a as the SDR conversion processing 2, and generates an SDR live-view image.

In step S410, since the control unit 201 is in the non-HDR shooting mode (SDR shooting mode), the control unit 201 causes the image processing unit 201a to generates an SDR live-view image.

In step S411, the control unit 201 determines whether or not a live-view image has been requested from the image display apparatus 300. If it is determined that a live-view image has been request from the image display apparatus 300, the control unit 201 advances the procedure to step S412, and, if it is determined that a live-view image has not been requested from the image display apparatus 300, advances the procedure to step S413.

In step S412, the control unit 201 transmits the live-view image generated in one of steps S405, S408, S409, and S410 to the image display apparatus 300.

In step S413, the control unit 201 determines whether or not to end live view. If it is determined that live view is to be ended, the control unit 201 ends the procedure, and if it is determined that live view is not to be ended, returns the procedure to step S404.

Processing of Image Display Apparatus 300

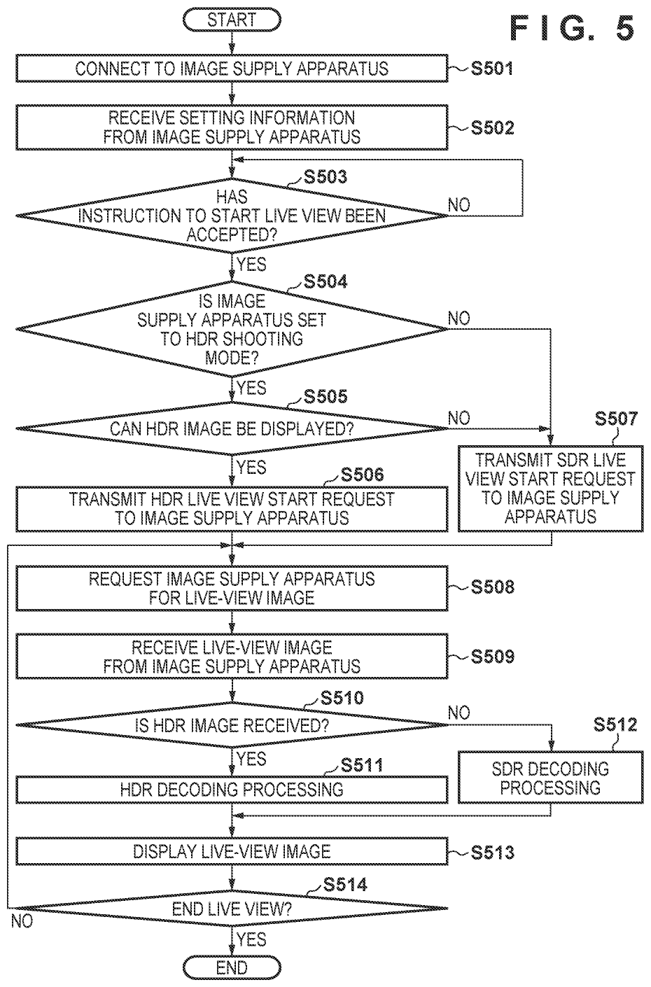

Next, processing of the image display apparatus 300 during remote shooting according to this embodiment will be described with reference to FIG. 5.

Note that the processing in FIG. 5 is realized by a CPU 301 of the image display apparatus 300 deploying a program stored in a ROM 302 to a RAM 303 and executing the program. In addition, assume that, in FIG. 5, an application of remote shooting has been started in the image display apparatus 300.

In step S501, the control unit 301 is communicably connected to at least one of the communication units 210, 211, 212 of the image supply apparatus 200 via the communication IF 307 and the communication unit 312.

In step S502, the control unit 301 receives setting information from the image supply apparatus 200. The setting information of the image supply apparatus 200 includes at least information regarding the HDR shooting mode of the image supply apparatus 200.

In step S503, the control unit 301 determines whether or not an instruction to start live view has been accepted through an operation performed by the user. If it is determined that a live view start instruction has been accepted. the control unit 301 advances the procedure to step S504, and, if it is determined that a live view start instruction has not been accepted, continues the processing until it is determined that a live view start instruction is accepted.

In step S504, the control unit 301 determines whether or not the image supply apparatus 200 is set to the HDR shooting mode, based on the setting information of the image supply apparatus 200 obtained in step S502. If it is determined that the image supply apparatus 200 is set to the HDR shooting mode, the control unit 301 advances the procedure to step S505, and, if it is determined that the image supply apparatus 200 is not set to the HDR shooting mode, advances the procedure to step S507.

In step S505, the control unit 301 determines whether or not the image display apparatus 300 and the display unit 311 have a capability of displaying an HDR image. If it is determined that the image display apparatus 300 and the display unit 311 have a capability of displaying an HDR image, the control unit 301 advances the procedure to step S506, and, if it is determined that the image display apparatus 300 and the display unit 311 do not have a capability of displaying an HDR image, advances the procedure to step S507. In order to determine whether or not the image display apparatus 300 and the display unit 311 have a capability of displaying an HDR image, it is necessary to determine whether or not the image display apparatus 300 and the display unit 311 can display an HDR image. The image display apparatus 300 includes a hardware portion such as a CPU and a software portion such as an OS recorded in the external storage device 304, each of which needs to comply with HDR. Furthermore, if the display setting of the image display apparatus 300 can be switched to SDR or HDR, HDR display setting needs to be set. In addition, the display unit 311 is required to be capable of receiving an HDR image, and comply with HDR image display. Furthermore, if the display setting of the display unit 311 can be switched to SDR or HDR, HDR display setting needs to be set.

In step S506, the control unit 301 transmits an HDR live view start request to the image supply apparatus 200.

In step S507, the control unit 301 transmits an SDR live view start request to the image supply apparatus 200.

In step S508, the control unit 301 requests the image supply apparatus 200 for a live-view image.

In step S509, the control unit 301 receives a live-view image from the image supply apparatus 200.

In step S510, the control unit 301 determines whether or not the live-view image received in step S509 is an HDR image. If it is determined that the live-view image received in step S509 is an HDR image, the control unit 301 advances the procedure to step S511, and if it is determined that the live-view image is an SDR image, advances the procedure to step S512.

In step S511, the control unit 301 controls the decoding unit 308 so as to decode the HDR live-view image received in step S509. The decoding processing is performed in accordance with the compression method of HDR image data. For example, if image data has been compressed to H.265 (ISO/IEC 23008-2 HEVC), the image data is converted into YCbCr (YUV422) data, and is then converted into 10-bit bitmap data.

In step S512, the control unit 301 controls the decoding unit 308 so as to decode the SDR live-view image received in step S509. The decoding processing is performed in accordance with the compression method of SDR image. For example, if image data has been compressed to the JPEG format, the image data is converted into 8-bit bitmap data.

In step S513, the control unit 301 displays the HDR live-view image decoded in step S511 or S512, on the display unit 311.

In step S514, the control unit 301 determines whether or not to end live view. If it is determined that live view is to be ended, the control unit 301 ends the procedure, and if it is determined that live view is not to be ended, returns the procedure to step S508.

Note that, in this embodiment, an example has been described in which, if it is determined in step S505 that the image display apparatus 300 and the display unit 311 do not have a capability of displaying an HDR image, the image supply apparatus 200 performs dynamic range conversion processing for converting an HDR image into an SDR image. In contrast, a configuration may also be adopted in which a request to change the mode from the HDR shooting mode to the non-HDR shooting mode is transmitted from the image display apparatus 300 to the image supply apparatus 200, and the image supply apparatus 200 transmits an SDR live-view image generated from a raw image to the image display apparatus 300. In this case, since an SDR image is generated from a raw image captured by the image supply apparatus 200, display different from that of the image generated in step S408 or step S409 in accordance with the dynamic range conversion function is obtained.

In addition, the image display apparatus 300 may receive an HDR image from the image supply apparatus 200, and generate an SDR image from the HDR image using an application, regardless of whether the image supply apparatus 200 is in the HDR shooting mode or the non-HDR shooting mode. In this case, the image display apparatus 300 requests the image supply apparatus 200 for an HDR live-view image, and performs dynamic range conversion processing into an SDR image using the application.

In addition, a case is conceivable in which the HDR display setting of the image display apparatus 300 or the display unit 311 is switched during processing, and a change is made from a state where an HDR image can be displayed to a state where it cannot be displayed. In this case, the live view start request that is transmitted from the image display apparatus 300 to the image supply apparatus 200 may be changed to an SDR live view start request.

In addition, processing for changing the display setting of the image display apparatus 300 to HDR when the image supply apparatus 200 is set to the HDR shooting mode but the display settings of the image display apparatus 300 and the display unit 311 are not HDR may be added. In addition, processing for transmitting a request to change the mode to the HDR shooting mode from the image display apparatus 300 to the image supply apparatus 200 when the display settings of the image display apparatus 300 and the display unit 311 are set to HDR but the image supply apparatus 200 is not set to the HDR shooting mode may be added.

Furthermore, when the image supply apparatus 200 is set to the SDR shooting mode but the display settings of the image display apparatus 300 and the display unit 311 are set to the HDR mode, the image supply apparatus 200 may perform dynamic range conversion processing for converting data from SDR into HDR. A configuration may be then adopted in which an HDR image generated through the conversion processing by the image supply apparatus 200 is transmitted to the image display apparatus 300 as a live-view image. Note that this HDR image is an image obtained based on a predetermined transfer function (PQ or HLG) of the aforementioned standard called Rec.ITU-R BT.2100.

As described above, according to this embodiment, it is possible to request and display an appropriate image in consideration of not only the display capability of the image display apparatus 300 but also the setting of the dynamic range of an image that is generated by the image supply apparatus 200. It is possible to request and display an appropriate image in consideration of the setting of an image that is generated by the image supply apparatus 200 as well.

### OTHER EMBODIMENTS

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-046382, filed Mar. 13, 2019 which is hereby incorporated by reference herein in its entirety.

What is claimed is:

1. An image display apparatus comprising:
a memory and at least one processor and/or at least one circuit;
a communication interface configured to communicate with an image supply apparatus; and
a display unit configured to display an image obtained from the image supply apparatus,
wherein the processor and/or the circuit function as a determination unit and a control unit, wherein
the determination unit is configured to determine, based on information obtained from the image supply apparatus via the communication interface, whether or not the image display apparatus has a capability of displaying an image of a first dynamic range that is generated in the image supply apparatus, and
the control unit is configured to, if the image display apparatus has a capability of displaying an image of the first dynamic range, request the image supply apparatus for an image of the first dynamic range, and if the image display apparatus does not have a capability of displaying an image of the first dynamic range, request the image supply apparatus for an image of a second dynamic range that can be displayed on the image display apparatus.

2. The apparatus according to claim 1, wherein
the image supply apparatus is an image capture apparatus that can be remotely controlled by the image display apparatus via the communication interface, and
an image of the first dynamic range and an image of the second dynamic range are live-view images captured by the image supply apparatus.

3. The apparatus according to claim 1, wherein
the image supply apparatus can be switched to a first mode for generating an image of the first dynamic range or a second mode for generating an image of the second dynamic range, and
the control unit is configured to, when the image supply apparatus is set to the second mode, request the image supply apparatus for an image of the second dynamic range.

4. The apparatus according to claim 3, wherein
the control unit is configured to, when the image display apparatus does not have a capability of displaying an image of the first dynamic range and the image supply apparatus is set to the first mode, request the image supply apparatus for an image of the second dynamic range.

5. The apparatus according to claim 1, wherein
the image supply apparatus can be switched to a first mode for generating an image of the first dynamic range or a second mode for generating an image of the second dynamic range, and
the control unit is configured to, when the image display apparatus does not have a capability of displaying an image of the first dynamic range and the image supply apparatus is set to the first mode, request the image supply apparatus to change from the first mode to the second mode.

6. The apparatus according to claim 1, wherein
the image supply apparatus can be switched to a first mode for generating an image of the first dynamic range or a second mode for generating an image of the second dynamic range, and
the control unit is configured to, when the image display apparatus does not have a capability of displaying an image of the first dynamic range and the image supply apparatus is set to the first mode, request the image supply apparatus for an image of the first dynamic range, and convert an image of the first dynamic range obtained from the image supply apparatus into an image of the second dynamic range.

7. The apparatus according to claim 1, wherein
the image supply apparatus can be switched to a first mode for generating an image of the first dynamic range or a second mode for generating an image of the second dynamic range, and
the control unit is configured to, when a setting of the image display apparatus is switched from a state where the image display apparatus has a capability of displaying an image of the first dynamic range to a state where the image display apparatus does not have a capability of displaying an image of the first dynamic range, change an image that is to be requested to the image supply apparatus from an image of the first dynamic range to an image of the second dynamic range.

8. The apparatus according to claim 1, wherein
the image supply apparatus can be switched to a first mode for generating an image of the first dynamic range or a second mode for generating an image of the second dynamic range, and
the control unit is configured to, when the image supply apparatus is set to the first mode but a setting of the image display apparatus is not a setting in which an image of the first dynamic range can be displayed, change the setting of the image display apparatus to a setting in which an image of the first dynamic range can be displayed.

9. The apparatus according to claim 1, wherein
the image supply apparatus can be switched to a first mode for generating an image of the first dynamic range or a second mode for generating an image of the second dynamic range, and
the control unit is configured to, when a setting of the image display apparatus is a setting in which an image of the first dynamic range can be displayed but the image supply apparatus is not set to the first mode, request the image supply apparatus to change to the first mode.

10. The apparatus according to claim 1, further comprising:
a receiving unit configured to receive data compressed using a compression method that is different according to a dynamic range of an image generated in the image supply apparatus, and
a decoding unit configured to perform decoding processing in accordance with a compression method of data received from the image supply apparatus.

11. The apparatus according to claim 1, wherein
the control unit is configured to transmit a live view start request of an image of the first dynamic range or an image of the second dynamic range to the image supply apparatus via the communication interface, and then transmits a live-view image request to the image supply apparatus.

12. The apparatus according to claim 1, wherein
the first dynamic range is an HDR (High Dynamic Range), and the second dynamic range is an SDR (Standard Dynamic Range).

13. An image supply apparatus comprising:
a memory and at least one processor and/or at least one circuit; and
a communication interface configured to communicate with an image display apparatus;
wherein the processor and/or the circuit function as a generation unit, a switching unit and a control unit, wherein
the generation unit is configured to generate images of different dynamic ranges,
the switching unit is configured to switch to a first mode for generating an image of a first dynamic range or a second mode for generating an image of a second dynamic range, and
the control unit is configured to, when an image of the first dynamic range is requested from the image display apparatus in a state where the first mode is set by the switching unit, supply an image of the first dynamic range generated by the generation unit to the image display apparatus, and, when an image of the second dynamic range is requested from the image display apparatus, cause the generation unit to generate an image of the second dynamic range, and supply the generated image to the image display apparatus.

14. The apparatus according to claim 13, wherein
the image supply apparatus is an image capture apparatus that includes an image capturing unit, and can be remotely controlled by the image display apparatus via the communication interface, and
an image of the first dynamic range and an image of the second dynamic range are live-view images captured by the image capturing unit.

15. The apparatus according to claim 14, wherein
the generation unit is configured to generate an image of the first dynamic range using a raw image captured by the image capturing unit.

16. The apparatus according to claim 13, wherein
when generating an image of the second dynamic range, the generation unit can execute dynamic range conversion processing in which a gradation higher than predetermined luminance is prioritized and dynamic range conversion processing in which a gradation lower than the predetermined luminance is prioritized.

17. The apparatus according to claim 13, wherein
the control unit is configured to transmit data compressed using a compression method in accordance with a dynamic range of an image generated by the generation unit, to the image display apparatus.

18. The apparatus according to claim 13, wherein
the generation unit is configured to, when a live view start request is received from the image display apparatus, generate an image of a dynamic range in accordance with a capability of displaying an image in the image display apparatus, and
the control unit is configured to, when a live-view image is requested from the image display apparatus, transmit a live-view image generated by the generation unit, to the image display apparatus.

19. The apparatus according to claim 13, wherein
the first dynamic range is an HDR (High Dynamic Range), and the second dynamic range is an SDR (Standard Dynamic Range).

20. A method of controlling an image display apparatus having a communication interface configured to communicate with an image supply apparatus, the method comprising:
determining, based on information obtained from the image supply apparatus via the communication interface, whether or not the image display apparatus has a capability of displaying an image of a first dynamic range that is generated in the image supply apparatus;
if the image display apparatus has a capability of displaying an image of the first dynamic range, requesting the image supply apparatus for an image of the first dynamic range, and if the image display apparatus does not have a capability of displaying an image of the first dynamic range, requesting the image supply apparatus for an image of a second dynamic range that can be displayed on the image display apparatus; and
displaying an image obtained from the image supply apparatus.

21. A method of controlling an image supply apparatus that includes a communication interface configured to communicate with an image supply apparatus and a generation unit configured to generate images of different dynamic ranges, and can be switched to a first mode for generating an image of a first dynamic range or a second mode for generating an image of a second dynamic range, the method comprising:
when an image of the first dynamic range is requested from the image display apparatus in a state where the first mode is set, supplying an image of the first dynamic range generated by the generation unit to the image display apparatus, and, when an image of the second dynamic range is requested from the image display apparatus, causing the generation unit to generate an image of the second dynamic range, and supplying the generated image to the image display apparatus.

22. A non-transitory computer-readable storage medium storing a program that causes a computer to execute a method of controlling an image display apparatus having a communication interface configured to communicate with an image supply apparatus, the method comprising:
determining, based on information obtained from the image supply apparatus via the communication interface, whether or not the image display apparatus has a capability of displaying an image of a first dynamic range that is generated in the image supply apparatus;
if the image display apparatus has a capability of displaying an image of the first dynamic range, requesting the image supply apparatus for an image of the first dynamic range, and if the image display apparatus does not have a capability of displaying an image of the first dynamic range, requesting the image supply apparatus for an image of a second dynamic range that can be displayed on the image display apparatus; and
displaying an image obtained from the image supply apparatus.

23. A non-transitory computer-readable storage medium storing a program that causes a computer to execute a method of controlling an image supply apparatus that includes a communication interface configured to communicate with an image supply apparatus and a generation unit configured to generate images of different dynamic ranges, and can be switched to a first mode for generating an image of a first dynamic range or a second mode for generating an image of a second dynamic range, the method comprising:
when an image of the first dynamic range is requested from the image display apparatus in a state where the first mode is set, supplying an image of the first dynamic range generated by the generation unit to the image display apparatus, and, when an image of the second dynamic range is requested from the image display apparatus, causing the generation unit to generate an image of the second dynamic range, and supplying the generated image to the image display apparatus.
